(19) United States
(12) Patent Application Publication
(10) Pub. No.: US 2018/0364149 A1
(43) Pub. Date: Dec. 20, 2018

(54) METHOD AND APPARATUS FOR REACTION LOADING

(71) Applicant: VOESTALPINE STAHL GMBH, Linz (AT)

(72) Inventors: Karl-Heinz Stellnberger, Linz (AT); Gerald Haslehner, Ansfelden (AT); Gerald Luckeneder, Pinsdorf (AT)

(21) Appl. No.: 16/060,921

(22) PCT Filed: Dec. 7, 2016
(86) PCT No.: PCT/EP2016/080159

§ 371 Date: Aug. 7, 2018

(30) Foreign Application Priority Data
Dec. 8, 2015 (EP) 15198497.8

(51) Int. Cl. G01N 17/00; F24F 6/10

(52) U.S. Cl. CPC G01N 17/002; G01N 2035/00455; F24F 6/10

(57) ABSTRACT

A method and an apparatus tier reaction loading at least one sample, comprising a loading chamber, which has a chamber air, for the sample, comprising at least one first and second saturated saline solution that, have different compositions, comprising a switching device as a function of whose switching position the loading chamber is operatively connected to the first or second saline solution in order to adapt the humidity of the chamber air in the loading chamber to the characteristic relative humidity by means of the respective saline solution, and comprising a device for influencing the humidity curve when the humidity of the chamber air in the loading chamber is being adapted to the characteristic relative humidity by means of the respective saline solution, characterized in that in addition to the respective saline solution, the device for influencing the humidity curve has a humidifier and/or dehumidifier that acts on the humidity of the chamber air.

### FIELD OF THE INVENTION

The invention relates to a method and apparatus for reaction loading at least one sample, comprising a loading chamber, which has a chamber air, for the sample, comprising at least a first and a second saturated saline solution that have different compositions, comprising a switching device as a function of whose switching position the loading chamber is operatively connected to the first or second saline solution in order to adapt the humidity of the chamber air in the loading chamber to the characteristic relative humidity by means of the respective saline solution, and comprising a device for influencing the humidity curve when the humidity of the chamber air in the loading chamber is being adapted to the characteristic relative humidity by means of the respective saline solution.

### BACKGROUND OF THE INVENTION

An apparatus for climatically testing a sample is known (DE4105440A1) in which a measurement chamber or loading chamber that is loaded with the sample is transported from one humidity chamber to the next humidity chamber. Saturated saline solutions with different compositions are provided in these humidity chambers, causing a characteristic relative humidity to develop, which is determined by the deliquescence humidity of the salt. The loading chamber is opened with a switching device, which causes the humidity of the chamber air in the loading chamber to be adapted to the characteristic relative humidity by means of the respective saline solution of the humidity chamber. Switching between the saturated saline solutions can indeed be used to adjust the humidity in the loading chamber in a comparatively precise way, but such an apparatus with its passive processes, disadvantageously entails a comparatively high expenditure of time. For this reason, DE4105440A1 also proposes providing a device embodied as a fan in the humidity chamber in order to influence the adaptation of the humidity in the loading chamber. Such a fan, however, can only partly produce a continuous humidity curve in the loading chamber; in addition, the action of such a fan can be subject to comparatively high fluctuations due to the varying charging height of the samples in the loading chamber and is therefore unpredictable. Such an apparatus is therefore unsuitable among other things for reaction loading procedures in which it is necessary to follow a predetermined change of the humidity in the loading chamber—as is the case, for example, in a cyclic corrosion test according to VDA 233-102.

A multitude of other apparatuses are known from the prior art, which use humidity sensors and ultrasonic vaporizers to adjust the respective humidity and humidity curve in the loading chamber. These are comparatively complex from a design and process standpoint and may require a constant calibration of the humidity sensors in order to be able to maintain the parameters that are required by the cyclic corrosion test.

### SUMMARY OF THE INVENTION

The object of the invention, therefore, is to create an apparatus for reaction loading with which it is possible to reproducibly adjust both the humidity and humidity curve in the loading chamber. In addition, the apparatus should be simply designed and easy to maintain.

The invention attains the stated object with regard to the apparatus in that in addition to the respective saline solution, the device for influencing the humidity curve has a humidifier and/or dehumidifier that acts on the humidity of the chamber air.

If in addition to the respective saline solution, the device for influencing the humidity curve has a humidifier and/or dehumidifier that acts on the humidity of the chamber air, then in addition to the humidity curve, which occurs based on the deliquescence humidity of the salt, the humidity in the loading chamber can also be adapted by active means. According to the invention, therefore, the humidity curve of the humidity in the loading chamber can be actively accelerated or decelerated as needed by adding or removing humidity—with which it is possible, for example, to overcome the sluggishness and accompanying time loss of a passive humidity curve and in this way, to create an apparatus that produces exact reaction loads.

In particular, however, the use of a humidifier and/or dehumidifier according to the invention can feature the fact that this active means for humidification or dehumidification can counteract the passive tendency of the chamber air in the loading chamber to approach the deliquescence humidity of the saline solution. The saline solution consequently exerts a damping effect on the action of the active means, which can, for example, improve a transient behavior of the humidity in the loading chamber from one deliquescence humidity to the next deliquescence humidity. In addition, this also permits the apparatus according to the invention to be embodied as comparatively robust in relation to, parameter fluctuations—which fluctuations can occur, for example, simply due to an unknown charging state in the loading chamber between the reaction loading procedures.

In addition, the saturated saline solution can ensure that despite any active humidification or dehumidification for controlling/regulating the humidity curve in the loading chamber, in the end, the humidity that develops in the loading chamber is exactly that which corresponds to the characteristic relative humidity produced by means of the respective saline solution. According to the invention, therefore, it is possible to insure not only an exact guidance of the humidity curve, but also an exact humidity in the loading chamber. It is therefore also possible to follow a comparatively complex humidity curve in order, for example, to subject the sample to a cyclic corrosion test according to VDA 233-102—the foregoing also being achieved without the comparatively complex regulating and controlling means known from the prior art, thus permitting the apparatus according to the invention to be simply designed.

In a simply designed way, the humidifier and/or dehumidifier can be provided in the loading chamber. It is also therefore possible to quickly influence the humidity in the loading chamber and thus also to achieve significantly higher dynamics in the humidity curve. This can be used to execute highly complex reaction loading procedures, which can permit versatile usability of the apparatus according to the invention.

The adjustment of the humidity curve can be further improved if the apparatus has a measuring device for determining the humidity in the loading chamber and a control or regulating device that is connected to the measuring device and is connected to the humidifier and/or dehumidifier in order to control or regulate its influence on the humidity of the chamber air in the loading chamber. To achieve this, the measuring device can be embodied, for example as a humidity sensor.

The humidity in the loading chamber can be adjusted in a comparatively exact way by providing the apparatus with a temperature control unit, which is embodied to adapt the temperature of the saline solution to the air temperature in the loading chamber. It is thus possible to use the saline solution to specifically compensate for temperature differences between the saline solution and the air so as to be able to also reliably transfer the known deliquescence humidity of saline solutions to the loading chamber. This temperature control unit can, for example, be embodied as an electric heating unit that thermally acts on the saline solution.

If the loading chamber has a basin and the switching device has a liquid connection that is connected to the basin and—as a function of its switching position—the switching device is embodied to replace the saline solution of the basin by means of the liquid connection, then it is possible to achieve a comparatively compact apparatus. It is also possible to use the control/regulation of the reaction parameters in the loading chamber to adjust the parameters of the saline solution, which can result in a design simplicity of the apparatus. In addition, in accordance with the size of the loading chamber, the appropriate basin size can also permit there to be a comparatively large surface of the saline solution. This can have a positive impact on the humidity curve, which can further promote the versatile usability of the apparatus.

The above-mentioned advantages are further increased if the basin, which is open at the top, extends across the entire bottom of the loading chamber since in this way, the relative characteristic humidity can be transferred more uniformly to the reaction chamber by means of the respective saline solution. It is thus possible to further improve the guidance of the humidity curve in the reaction chamber. This also makes it possible to insure a uniform reaction loading of the samples in the loading chamber and to do so regardless of the charging height of the samples in the loading chamber.

In a simply embodied way, the temperature control unit can be provided in the saline solution in the basin to allow the temperature of the saline solution to be adapted exactly to the air temperature in the loading chamber.

If the apparatus has a separate humidity chamber for each saline solution and the switching device has a gas connection connected to the loading chamber and humidity chambers and—as a function of its switching position—the switching device is embodied to connect the humidity chambers to the loading chamber by means of the gas connection, then the loading chamber can remain free of the saline solution. Among other things, this can prevent a contamination of the saline solution and can thus promote the reproducibility of the reaction loading. It is also thus conceivable to easily and inexpensively retrofit existing apparatuses with the idea according to the invention.

If the gas connection has means for controlling the temperature of the gas flow, then it is possible to reduce possible interfering influences on the control/regulation of the reaction parameters in the loading chamber due to the addition of the relative characteristic humidity of the saline solution. This enables achievement of an exact humidity curve in the loading chamber—which promotes the versatile usability of the apparatus. Among other things, such means can be composed of electric heating or cooling elements.

Another stated object of the invention is to create a method for reaction loading at least one sample, which has a high reproducibility.

The invention attains the stated object in that this adaptation of the humidity to a characteristic relative humidity of the second saline solution is influenced with the aid of a humidifier and/or dehumidifier.

If in addition to the effect of the respective saline solution on the humidity, the humidity curve is influenced by humidification or dehumidification, then the method can be embodied as comparatively robust in relation to parameter fluctuations—which fluctuations can occur, for example, simply due to a varying charging state in the loading chamber. In addition (for example with a humidifier and/or dehumidifier), it is possible to responsively govern to parameter deviations, which can enable an exact reaction loading that complies with requirements. The method can therefore have a comparatively high reproducibility.

The reproducibility of the method can be further improved if the sample is provided in a loading chamber and the chamber air of the loading chamber is humidified or dehumidified in order to influence the humidity curve.

### BRIEF DESCRIPTION OF THE DRAWINGS

In the drawings, the subject of the invention is depicted in greater detail by way of example based on several embodiment variants. In the drawings:

FIG. 1 shows a schematic view of an apparatus for reaction loading according to a first exemplary embodiment,

FIG. 2 shows a schematic view of an apparatus for reaction loading according to a second exemplary embodiment, and

FIG. 3 shows a humidity and temperature guidance in the loading chamber of the apparatuses shown in FIGS. 1 and 2.

### DETAILED DESCRIPTION OF THE PREFERRED EMBODIMENTS

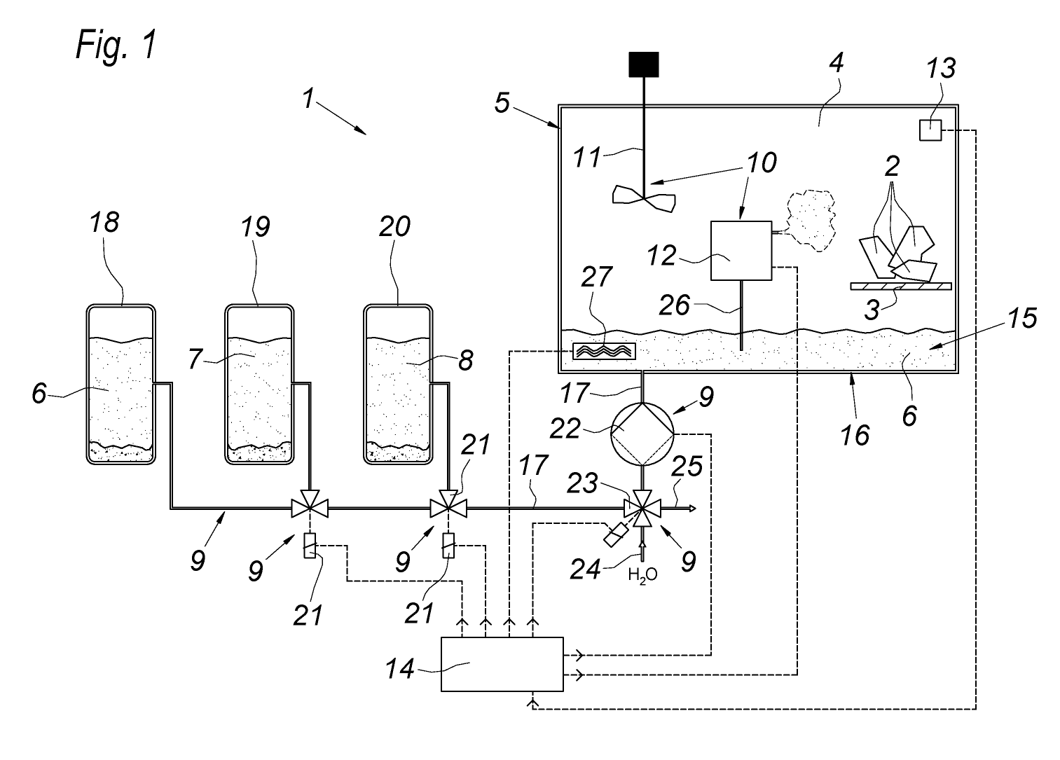

FIG. 1 shows an example of an apparatus 1 for reaction loading a plurality of samples 2. For this purpose, these samples 2 are provided in a sample holder 3, which is interchangeably mounted in the loading chamber 4 of the test chamber 5 of the apparatus 1.

The apparatus 1 also has a plurality of saturated saline solutions 6, 7, 8 with different compositions. In this exemplary embodiment, the first saturated saline solution 6 has NaCl as a salt, the second saturated saline solution 7 has NH₄NO₃ as a salt, and the third saturated saline solution 8 has MgSO₄ as a salt.

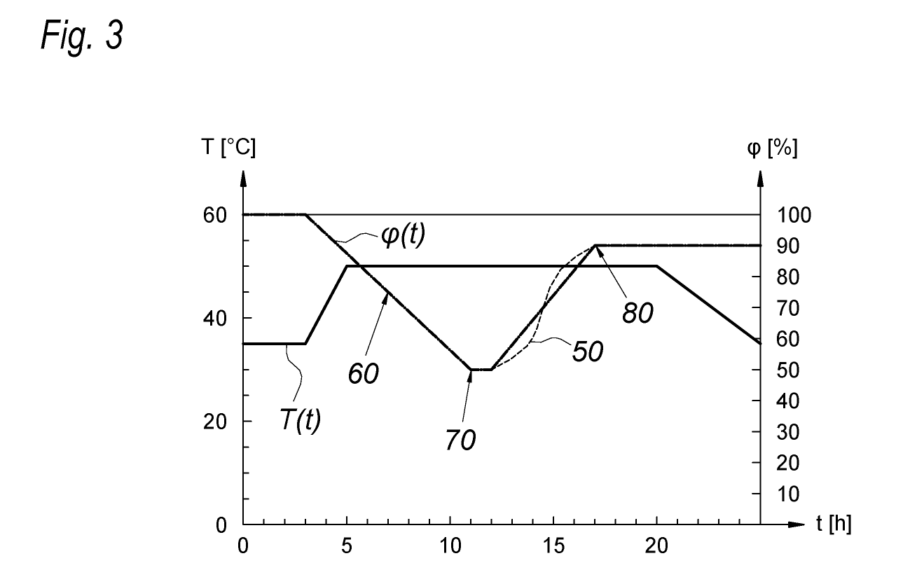

With the aid of a switching device 9 and as a function of the latter's switching position, the loading chamber 4 is connected to the first, second, or third saline solution 6, 7, 8 in order to thus adapt the relative humidity φ of the chamber air in the loading chamber 4 to the characteristic relative humidity 60, 70, 80 by means of the respective saline solution 6, 7, 8, which adaptation is shown by way of example in FIG. 3. This yields a humidity curve φ(t) in the loading chamber 4, which starts from a relative humidity φ of 60%, passes through the characteristic relative humidities and deliquescence humidities 60, 70 of the saline solutions 6, 7, and arrives at the characteristic relative humidity and deliquescence humidity 80 of the saline solution 8.

In the loading chamber 4 of the test chamber 5 of the apparatus 1 a device 10 is provided in order to influence the humidity φ of the chamber air in the loading chamber 4—namely to adapt the humidity φ of the chamber air in the loading chamber 4 to the characteristic relative humidity 60, 70, 80 by means of the respective saline solution 6, 7, 8. This device 10 can, for example, be embodied in the form of a fan 11, which serves to homogenize the humidity φ of the chamber air in the loading chamber 4. A fan 11, however, is not suitable for adjusting a predetermined humidity curve φ(t)—of the kind that is shown by way of example in. FIG. 3. According to the invention, this is enabled by the fact that the device 10 has a humidifier/dehumidifier 12 that is connected to the loading chamber. It should be generally noted that the humidifier and/or dehumidifier 12 is embodied for evaporating and/or condensing liquid. It is thus possible, in accordance with the requirement regarding the humidity curve φ(t), to perform an active increase or reduction, as needed, of the humidity φ of the chamber air in the loading chamber 4, which enables particularly high dynamics in the humidity curve φ(t). To this end, the humidifier/dehumidifier 12 has an ultrasonic vaporizer for vaporizing liquid and condensation surfaces of a cooling unit for condensing liquid.

The method according to the invention is shown by way of example between the deliquescence humidities 70 and 80 in FIG. 3. The passive humidity change 50 of the humidity φ acting on the sample with the aid of the deliquescence humidity 80 of the saline solution 8 is thus depicted in comparatively exaggerated form in this range. As is apparent from the deliquescence humidity 70 in the curve of the passive humidity change 50, this passive humidity change does not correspond to the desired humidity curve φ(t). The humidifier/dehumidifier 12 intervenes here in a regulating fashion in that—in addition to the passive humidification of the humidity φ acting on the sample 2—it actively enriches the chamber air with humidity in order to correspond to the desired humidity curve φ(t). After the intersection point of the two curves, namely the passive humidity change 50 and the desired humidity curve φ(t), the humidifier/dehumidifier 12 exerts a dehumidifying action on the chamber air acting on the sample 2—so that here, too, correspondence with the desired humidity curve φ(t) is achieved through active removal of humidity from the chamber air.

In addition, this active humidification works together with the passive humidification of the saline solution or counteracts it—the latter exerting a damping action on the transient behavior from a first deliquescence humidity 60 or 70 to a second deliquescence humidity 70 or 80 and can thus keep the humidity curve φ(t) within strict limits. The apparatus 1 according to the invention can thus reproducibly insure a stable reaction loading.

In addition, a measuring device 13 is provided in the loading chamber 4 in order to determine the humidity φ and has a humidity sensor that is not shown in detail. This measuring device 13 is connected to a control or regulating unit 14. With the aid of this control or regulating unit 14, the actual value of the humidity φ from the measuring device 13 can be continuously adapted to a predetermined desired value through a controlled regulation of the device 10. Such a variable desired value of the humidity φ in the loading chamber 4 can, for example, have a curve shape over time like the one shown in FIG. 3. A humidification or dehumidification of the chamber air in the loading chamber 4 can therefore enable a particularly precise adaptation of the humidity φ to a predetermined humidity curve φ(t).

The apparatus 1 also has a temperature control unit 27, which controls the temperature of the respective saline solution 6, 7, 8 that is connected to the loading chamber 4. This serves to adapt the temperature of the saline solution 6, 7, 8 to the air temperature T in the loading chamber, which permits an exact adjustment of the humidity φ—even if the air temperature T, expressed in degrees Celsius in FIG. 3, changes over time. To this end, the temperature control unit 27 embodied as an electric heating unit is provided in the respective saline solution 6, 7, 8, which is introduced into a basin 15 that is situated in the loading chamber 4 of the test chamber 5. The basin 15, which is open at the top, extends across the entire bottom 16 of the loading chamber 4, thus homogenizing the reaction loading across the loading chamber 4. The apparatus 1 can therefore reproducibly insure uniform conditions in the reaction loading in every region of the loading chamber 4, which also makes this apparatus insensitive to the charging heights of the samples 2.

To introduce the respective saturated saline solution 6, 7, 8 into the basin 15 of the test chamber 5, the switching device 9 has a liquid connection 17 embodied in the form of a liquid line 17 by means of which the reservoirs 18, 19, 20 with the saturated saline solutions 6, 7, 8 are connected to the basin 15. With valves 21 of the switching device 9, which are provided in the liquid connection 17 and are controlled by the control or regulating unit 14, the respective reservoir 18, 19, 20 can be selected by the switching device 9. The saturated saline solution 6, 7, 8 can consequently be removed from the respective reservoirs 18, 19, 20 via the liquid connection 17. As a function of the switching position of its valves 21, the switching device 9 can replace the saline solution 6 in the basin 15 with the saline solution 7 in the reservoir 19 or more precisely stated, can convey the saline solution 6 in the basin 15 back into the reservoir 18 and then introduce the saline solution 7 from the reservoir 19 into the empty basin 15. The replacement of the saline solutions 6, 7, 8 is achieved by means of a pump 22 of the switching device 9, which is control-connected to the control or regulating unit 14.

Via a maintenance valve 23, the liquid connection 17 is also fed by a rinsing line 24 with which the apparatus 1 can be cleaned by means of a rinsing liquid such as H₂O. This supplied rinsing liquid can be discharged from the apparatus 1 via the maintenance valve 23 through a discharge line 25. In addition, the rinsing line 24 can also be used, if necessary, to perform a filling of the reservoir 18, 19, 20—for example in order to compensate for any liquid losses due to evaporation. The maintenance valve 23 is likewise part of the switching device 9 and is connected to the control or regulating unit 14.

As is also clear from FIG. 1, the humidifier and/or dehumidifier 12 is provided in the loading chamber 4. It is thus possible to quickly act on the humidity φ in the loading chamber 4—thus making it possible to exactly follow a predetermined humidity curve. The humidifier/dehumidifier 12 draws the liquid, which is to be evaporated, from the basin 15 and in order to do so, dips a suction tube 26 into the respective saline solution 6 of the basin 15. During dehumidification, the suction tube 26 can be used to convey the condensed liquid into the basin 15.

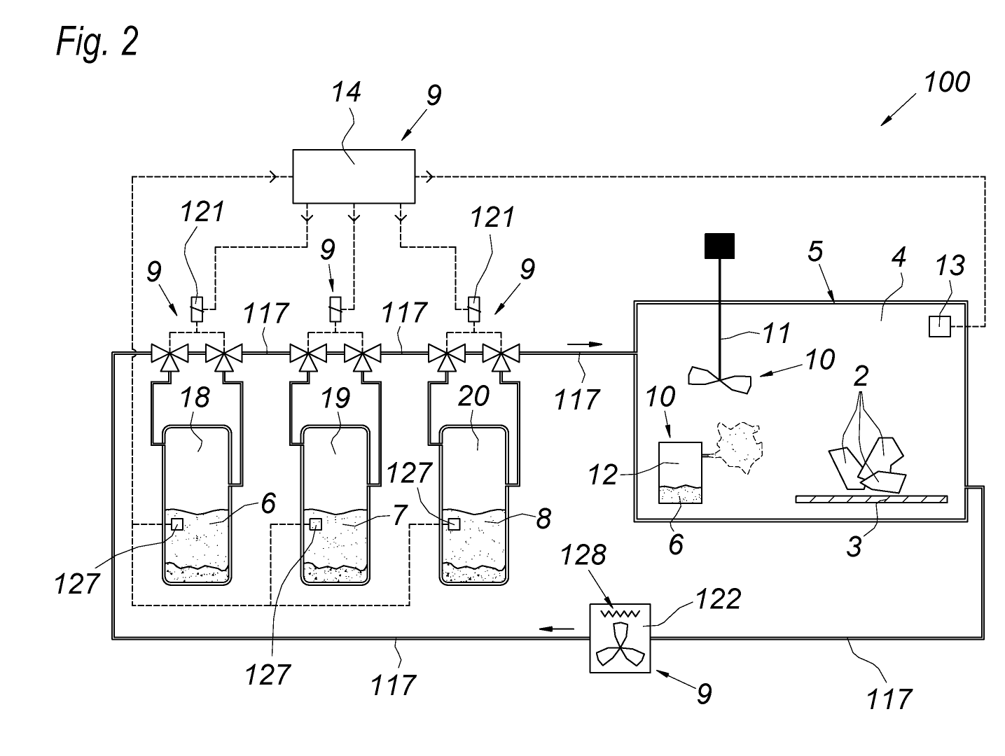

The apparatus 100 shown in FIG. 2 differs from the apparatus 1 shown in FIG. 1 essentially in that the saline solutions 8, 9, 10 are not introduced into the reaction chamber 4 of the test chamber 5 of the apparatus 1. In the apparatus 100, the switching device 9 connects the loading chamber 4 to the respective saline solution 8, 9, 10 by means of a gas connection 117 embodied in the form of a gas line. The gas connection 117 is connected via valves 121 of the switching device 9 to the reservoirs 18, 19, 20 in which the saline solutions 8, 9, 10 are contained so that the characteristic relative humidity 60, 70, 80 can be introduced into the loading chamber 4 by means of the respective saline solution 6, 7, 8. To this end, the relevant valves 121 can be correspondingly controlled by the control or regulating unit 14. By means of the gas connection 117, the loading chamber 4 is forced to assume the respective characteristic relative humidity 60, 70, 80 or deliquescence humidity or more precisely stated, the humidity φ in the loading chamber 4 is adapted to this characteristic relative humidity.

To guide the humidity φ in the loading chamber 4, the apparatus 100—like the apparatus 1—has a humidifier and/or dehumidifier 112 in the loading chamber 4. This humidifier/dehumidifier 112, however, can also be provided at another point, for example in the gas connection 117 or in each reservoir 18, 19, 20. The humidifier/dehumidifier 112 itself stores the saline solution 6 that is to be evaporated or the liquid that is drawn from the loading, chamber 4—it is in general also conceivable to use water in the humidifier:dehumidifier 112.

The switching device 9 is also associated with a blower 122, which assists the gas connection between the reservoirs 18, 19, 20 and the loading chamber 4. The gas connection 117 also has a means 128 for controlling the temperature of the gas flow, which means 117 is embodied in a simply designed way in the form of an electric heating unit on the blower 122.

1. An apparatus for reaction loading at least one sample, the apparatus comprising:
a loading chamber, which has a chamber air, tar the sample, the chamber air comprising at least to first saturated saline solution and a second saturated saline solution having a different composition than the first saturated saline solution:
a switching device as a function of whose switching position the loading chamber is operatively connected to the first or second saline solution in order to adapt a humidity (φ) of the chamber air in the loading chamber to a characteristic relative humidity by means of the respective saline solution, and
a device for influencing a humidity curve (φ(t)) when the humidity (φ) of the chamber air in the loading chamber is being adapted to the characteristic relative humidity by means of the respective saline solution, the device for wherein in addition to the respective saline solution, the device for influencing the humidity curve (φ(t)) has a humidifier and/or dehumidifier that acts on the humidity (φ) of the chamber air.

2. The apparatus according to claim 1, wherein the humidifier and/or dehumidifier is provided in the loading chamber.

3. The apparatus according to claim 1, further comprising:
a measuring device for determining the humidity (φ) in the loading chamber; and
a control or regulating unit that is connected to the measuring device and is connected to the humidifier and/or dehumidifier in order to control or regulate its influence on the humidity (φ) of the chamber air in the loading chamber.

4. The apparatus according to claim 1, further comprising a temperature control unit, which is embodied to adapt a temperature of the saline solution to an air temperature in the loading chamber.

5. The apparatus according to claim 1, wherein the loading chamber has a basin and the switching device has a liquid connection that is connected to the basin and—as a function of its switching position—the switching device replaces the saline solution of the basin through the liquid connection.

6. The apparatus according to claim 5, wherein the basin, which is open at a top, extends across an entire bottom of the loading chamber.

7. The apparatus according to claim 5, wherein a temperature control unit is provided in the saline solution in the basin.

8. The apparatus according to claim 1, wherein the apparatus has a separate humidity chamber for each saline solution and the switching device has a gas connection connected to the loading chamber and the humidity chambers and—as a function of its switching position—the switching device connects the humidity chambers to the loading chamber through the gas connection.

9. The apparatus according to claim 8, wherein the gas connection can control a temperature of the gas connection.

10. A method for reaction loading at least one sample, the method comprising:
with the aid of saturated saline solutions that have different chemical compositions, adapting a humidity (φ) acting on the sample from a characteristic relative humidity of a first saline solution to a characteristic relative humidity of a second saline solution and with this adaptation, influencing a humidity curve (φ(t)), wherein in addition to an effect of the respective saline solution on the humidity (φ), the humidity curve (φ(t)) is influenced by humidification or dehumidification.

11. The method according to claim 10, comprising providing the sample in a loading chamber and humidifying or dehumidifying the chamber air of the loading chamber in order to influence the humidity curve (φ(t)).
